(19) United States
(12) Patent Application Publication
(10) Pub. No.: US 2010/0095162 A1
(43) Pub. Date: Apr. 15, 2010

(54) METHOD AND APPARATUS FOR PERFORMANCE BOTTLENECK ANALYSIS

(75) Inventor: Hiroya Inakoshi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/576,944

(22) Filed: Oct. 9, 2009

Related U.S. Application Data
(63) Continuation of application No. PCT/JP2007/058077, filed on Apr. 12, 2007.

(51) Int. Cl. G06F 11/34

(52) U.S. Cl. 714/45; 714/E11.192

(57) ABSTRACT

Provided is a method for outputting information related to a bottleneck point in a program based on trace records that are output when a predetermined point of the program is executed. The method includes generating candidate patterns of the trace records in an array in which the trace records are stored in an output order, counting the number of occurrences of parts matched with each generated candidate in the array, extracting, when the number of occurrences of the generated candidate pattern is not less than a predetermined occurrence threshold, the candidate pattern as a frequent pattern to obtain an extraction result based on the counted number of occurrences, and outputting the extraction result as an analysis result.

### CROSS-REFERENCE TO RELATED APPLICATION(S)

This application is a continuation of PCT international application Ser. No. PCT/JP2007/058077 filed on Apr. 12, 2007 which designates the United States, the entire contents of which are incorporated herein by reference.

### FIELD

The embodiments discussed herein are directed to a method and apparatus for outputting information related to a bottleneck point in a program based on trace records that are output when a predetermined point of the program is executed.

### BACKGROUND

For optimization of a performance of a program, it is effective to improve a part which is executed many times and requires long execution time (i.e., runtime). Conventionally, techniques have been widely used for adding up the number of runs (executions) and the length of runtimes for each function based on information collected during the execution of the program. One example of such techniques is disclosed in Japanese Laid-open Patent Publication No. 2002-175202.

When the number of runs and the length of runtimes are added up for each function, however, sometimes it is difficult to find out a part, which is a performance bottleneck point, because of the granularity of functions. For example, when a part executed frequently is divided into sub-parts and the sub-parts are assigned to a plurality of functions, the part may not be distinguished from other parts because the runtime of each function is short. Conversely, a part less frequently executed may be recognized as a part causing a performance bottleneck, if the part is not divided into sub-parts of functions and the runtime is long.

### SUMMARY

According to an aspect of the invention, a method for outputting information related to a bottleneck point in a program based on trace records that are output when a predetermined point of the program is executed, the method includes generating candidate patterns of the trace records in an array in which the trace records are stored in an output order, counting the number of occurrences of parts matched with each generated candidate pattern in the array, extracting, when the number of occurrences of the generated candidate pattern is not less than a predetermined occurrence threshold, the candidate pattern as a frequent pattern to obtain an extraction result based on the counted number of occurrences, and outputting the extraction result as an analysis result.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of a source file in which a macro for outputting a trace record is embedded;

FIG. 2 is a diagram illustrating an example of an output trace record;

FIG. 3 is a diagram illustrating an example of an analysis result of a performance bottleneck analysis method according to an embodiment;

FIG. 4 is a block diagram of a configuration of a performance bottleneck analysis apparatus according to an embodiment;

FIG. 5 is a diagram illustrating an example of candidate pattern data;

FIG. 6 is a diagram illustrating an example of frequent pattern data;

FIG. 7 is a diagram illustrating an example of the list of the trace record;

FIG. 8A is a diagram illustrating an example of NFAf;

FIG. 8B is a diagram illustrating an example of NFAb;

FIG. 9 is a diagram illustrating a detection example of a candidate pattern using NFA;

FIG. 10 is a flowchart of a processing procedure of the performance bottleneck analysis apparatus;

FIG. 11 is a flowchart of a processing procedure of a candidate pattern generation process;

FIG. 12 is a flowchart of a processing procedure of an occurrence counting process;

FIG. 13 is a flowchart of a processing procedure of a frequent pattern extraction process; and

FIG. 14 is a functional block diagram of a computer for executing a performance bottleneck analysis program.

### DESCRIPTION OF EMBODIMENTS

Exemplary embodiments of a performance bottleneck analysis program and a performance bottleneck analysis apparatus according to the present invention will be explained in detail below with reference to the accompanying drawings. The present invention is not limited to the embodiments explained below.

Firstly, a performance bottleneck analysis method according to an embodiment will be explained briefly. In the performance bottleneck analysis method, a part having a possibility of causing a performance bottleneck is extracted based on a trace record output at the time of the execution of the program. The trace record is a record that is output to a file or the like according to a macro or a function that is embedded at an arbitrary point in a source file of the program.

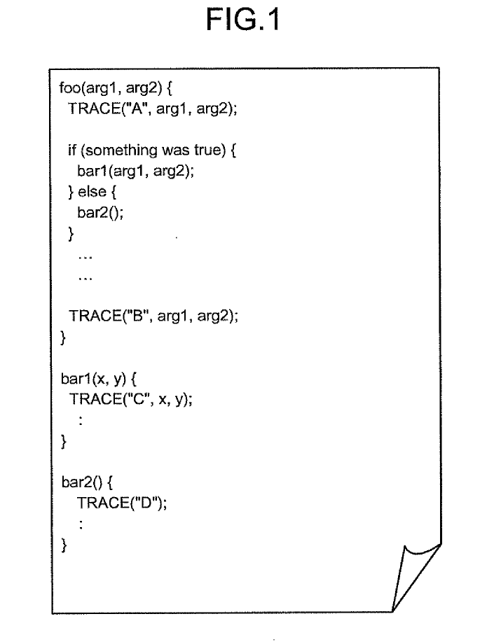

FIG. 1 is a diagram illustrating an example of a source file in which a macro for outputting a trace record is embedded. In the example of FIG. 1, macros called TRACE are embedded at various points in a source file of a program. TRACE may have one or more arguments. Whenever a part where the macro is embedded is executed, given arguments, time, and the like are output as a trace record. A first argument of TRACE designates the type of record for identifying the position at which the TRACE is embedded. Arguments after the first argument arbitrarily designate, for example, the values of variables to be output when the TRACE is executed.

To prevent the output of trace records from causing performance degradation of a program or consumption of a storage area, the trace record may be output only when a source file is compiled or only when a predetermined option is designated at the time of execution of the program.

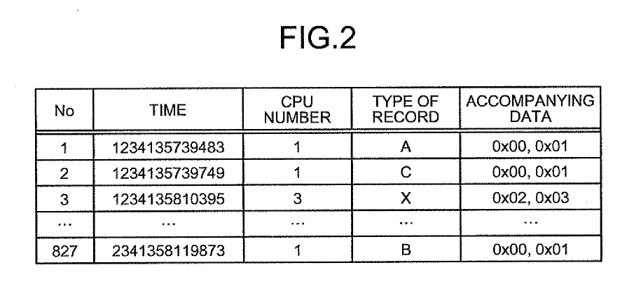

FIG. 2 is a diagram illustrating an example of an output trace record. As illustrated in FIG. 2, the trace record has items such as a record number (No), a time, a CPU (Central Processing Unit) number, the type of record, and accompanying data. The record number is consecutive numbers assigned in the order of output of the trace record. The time is a time at which a function or a macro for outputting the trace record is executed. The CPU number is the identification number of a CPU that executes the function or the macro. The type of record is the first argument of TRACE. The accompanying data is arguments after the first argument of TRACE.

In the performance bottleneck analysis method according to the embodiment, a pattern which frequently appears in the list of trace records, arranged in the order of execution, is extracted and output in order to specify a part which is frequently executed.

In actual operations, the sameness of trace records may be determined by comparing the accompanying data as well as the type of record. When a plurality of CPUs is used to execute the program, the sameness of trace records may be determined by further comparing the CPU numbers. Moreover, trace records may be divided and analyzed for each CPU number. To simplify the explanation, in the embodiment, it is assumed that the sameness of trace records is determined based only on the type of record.

Trace records are not output at uniform time intervals. However, runtime can be calculated accurately by acquiring the time recorded in the first trace record and the last trace record in a group of trace records having the same pattern and using the difference between the acquired, recorded times as the execution time of the group of trace records. To simplify the explanation, in the following detailed explanation, the time interval of the output of trace records is assumed to be uniform, and an occurrence length is adopted as the execution time. However, extension can be readily made to use the aforementioned time difference as the execution time.

A pattern of occurrence of the trace records is represented by the combination of the type of record and a symbol “*” indicating any of the types of record. For example, “A*B” represents a pattern in which a trace record “A” appears first, followed by zero or more trace records of any types, and a trace record “B”.

In the performance bottleneck analysis method according to the embodiment, to specify a part having a long runtime, a frequent pattern is extracted in consideration of an occurrence length. The occurrence length is the number of records in a trace record group matched with a pattern. For example, when trace records having the types of record such as “A” “C” “D” “W” “S” “B” “F” “A” “S” “B” are arranged in this order, a trace record group “A” “C” “D” “W” “S” “B” and a trace record group “A” “S” “B” match with the pattern “A*B”. The occurrence length of the former trace record group is six and the occurrence length of the latter is three.

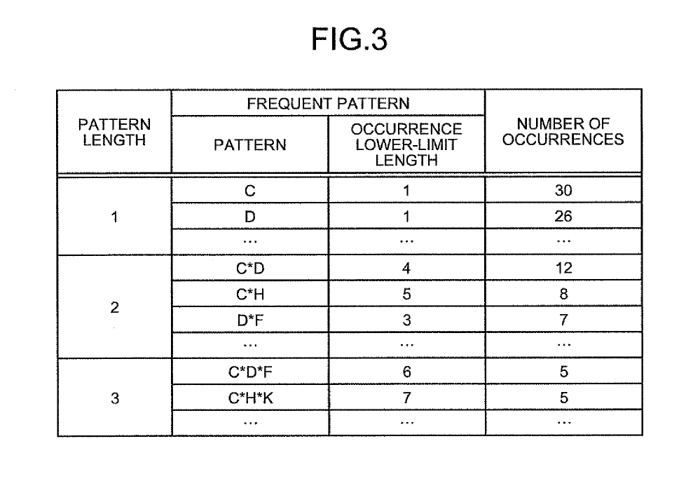

FIG. 3 is a diagram illustrating an example of the result of analysis according to the performance bottleneck analysis method of the embodiment. As illustrated in FIG. 3, the analysis result includes items such as a pattern length, a frequent pattern, and the number of occurrences. The pattern length is the number of keys for determining the sameness of trace records. In the embodiment, the pattern length is the number of records included in the pattern (however, the record represented as “*” is not counted). The frequent pattern is defined by a pattern and an occurrence lower-limit length. The frequent pattern is a pattern with a length not less than the occurrence lower-limit length and appears in the list of trace records a predetermined number of times or more. The number of occurrences is the number of occurrences of the frequent pattern.

In the performance bottleneck analysis method according to the embodiment, it can be considered that a part corresponding to a frequent pattern with a long pattern length and a large number of occurrences has a possibility of causing a performance bottleneck. For example, in the example of FIG. 3, it can be considered that a part corresponding to “C*D*F” and a part corresponding to “C*H*K” have a possibility of causing a performance bottleneck. Moreover, by appropriately designating an occurrence length, a part that may have a performance bottleneck can be extracted in consideration of a runtime.

In this manner, in the performance bottleneck analysis method according to the embodiment, a part of which the number of runs is large and the runtime is long is extracted based on an output pattern of trace records output according to a function or a macro embedded at an arbitrary point in the source program. Therefore, a part that has a possibility of causing a performance bottleneck can be extracted irrespective of the granularity of functions.

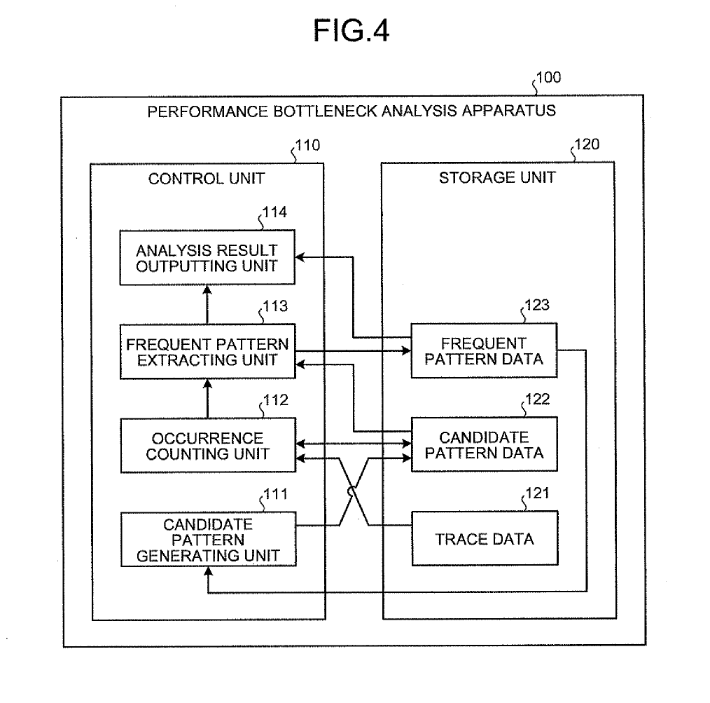

Next, the configuration of a performance bottleneck analysis apparatus 100 that executes the performance bottleneck analysis method according to the embodiment will be explained. FIG. 4 is a block diagram of a configuration of the performance bottleneck analysis apparatus 100. As illustrated in FIG. 4, the performance bottleneck analysis apparatus 100 includes a control unit 110 and a storage unit 120.

The control unit 110 controls the performance bottleneck analysis apparatus 100 and includes a candidate pattern generating unit 111, an occurrence counting unit 112, a frequent pattern extracting unit 113, and an analysis result outputting unit 114.

The candidate pattern generating unit 111 generates a candidate pattern that is a candidate of a frequent pattern and makes the storage unit 120 store the candidate pattern as candidate pattern data 122. The number of patterns that can exist in the trace record increases in proportion to a pattern length. Therefore, the candidate pattern generating unit 111 generates a candidate pattern whose pattern length is two or more, by combining frequent patterns extracted by the frequent pattern extracting unit 113 so that the increase in the number of candidate patterns would not cause lengthening of the processing time.

The occurrence counting unit 112 counts the number of occurrences of each candidate pattern generated by the candidate pattern generating unit 111 and makes the candidate pattern data 122 store the result, with reference to trace data 121 in which trace records are arrayed in an output order. The trace data 121 has the same data structure as that of the list of trace records illustrated in FIG. 2 and is stored in the storage unit 120.

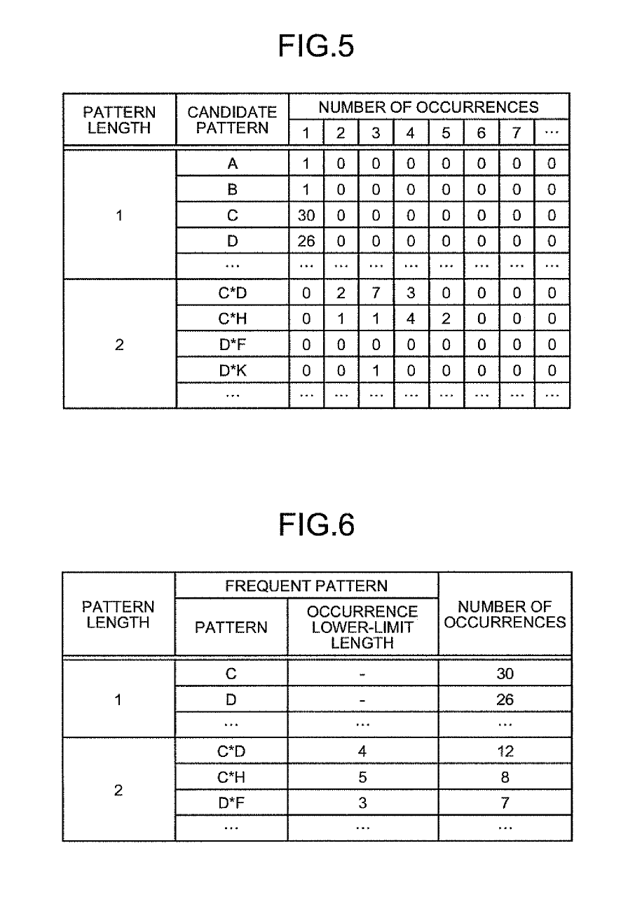

FIG. 5 is a diagram illustrating an example of the candidate pattern data 122. As illustrated in FIG. 5, the candidate pattern data 122 includes items such as a pattern length, a candidate pattern, and the number of occurrences. The pattern length is an item where the number of keys for determining the sameness of trace records is set. In other words, the pattern length is the number of records included in a pattern (except “*”) in the embodiment. The candidate pattern is an item where a pattern generated by the candidate pattern generating unit 111 is set. The number of occurrences is an item where the number of occurrences of the candidate pattern counted by the occurrence counting unit 112 is set. The number of occurrences is set for each occurrence length.

The frequent pattern extracting unit 113 extracts a candidate pattern, whose number of occurrences is larger than a predetermined value, as a frequent pattern based on the number of occurrences counted by the occurrence counting unit 112 and makes the storage unit 120 store the extracted candidate pattern as frequent pattern data 123. The predetermined value for determining whether the candidate pattern is a frequent pattern or not can be different for each pattern length.

FIG. 6 is a diagram illustrating an example of the frequent pattern data 123. As illustrated in FIG. 6, the frequent pattern data 123 includes items such as a pattern length, a frequent pattern, and the number of occurrences. The pattern length is an item where the number of keys for determining the sameness of trace records is set. In other words, the pattern length is an item where the number of records included in a pattern (except “*”) is set in the embodiment. The frequent pattern is an item where a frequent pattern extracted by the frequent pattern extracting unit 113 is set. The number of occurrences is an item where the number of occurrences of the frequent pattern is set.

After the extraction of the frequent pattern is completed, the analysis result outputting unit 114 outputs an analysis result as depicted in FIG. 3.

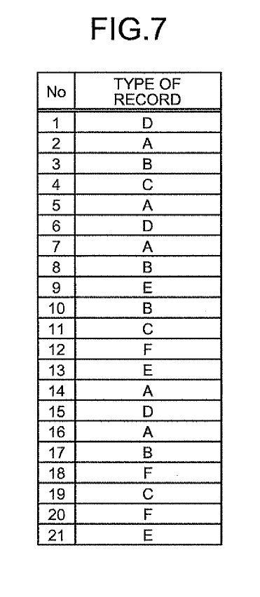

Next, a process for counting the number of occurrences of a candidate pattern performed by the occurrence counting unit 112 will be explained in detail. For example, when the record types of trace records arrayed in the output order are as illustrated in FIG. 7, many parts are matched with a pattern “A*B*C”, and these parts can be represented in a list format as follows by the numbers of record (No) of the trace records having the same types of records as those in the pattern “A*B*C”.
(2, 3, 4), (2, 3, 11), (2, 3, 19), (2, 8, 11),
(2, 8, 19), (2, 10, 11), (2, 10, 19),
(2, 17, 19), (5, 8, 11), (5, 8, 19),
(5, 10, 11,) (5, 10, 19), . . . (16, 17, 19)

In the performance bottleneck analysis method according to the embodiment, overlapping parts are not counted redundantly as the number of occurrences. Nevertheless, depending on a separating method of parts matched with the pattern, the number of occurrences and the occurrence lower-limit length may be changed. For example, assume that a threshold value for determining whether the pattern is a frequent pattern or not is one. In this case, if the list is separated into parts (2, 3, 4), (5, 8, 11), and (14, 17, 19), the number of occurrences is three and the occurrence lower-limit length is seven. If, however, the list is separated into parts (2, 3, 4), (7, 8, 11), and (16, 17, 19), the number of occurrences is three and the occurrence lower-limit length is five. Moreover, the number of occurrences is one and the occurrence lower-limit length is 18 if the list is separated into (2, 3, 19).

In the performance bottleneck analysis method according to the embodiment, to avoid the fluctuation in the number of occurrences and the occurrence lower-limit length, parts matched with a pattern are separated so that the occurrence length is minimum. Specifically, when parts matched with the pattern “A*B*C” are extracted from the list of trace records illustrated in FIG. 7, the list is separated into (2, 3, 4), (7, 8, 11), and (16, 17, 19).

The part having a long occurrence length, such as (5, 8, 11), is also matched with a pattern having a longer pattern length such as “A*A*B*C”. The part is output as a frequent pattern when the pattern having a longer pattern length appears frequently. Therefore, the above separating method which makes the occurrence length minimum may be the most suitable method for counting up the number of occurrences of a candidate pattern which is currently checked.

In this manner, to count the number of occurrences of the candidate pattern while separating the list to make the occurrence length minimum, the occurrence counting unit 112 detects the occurrence of the candidate pattern by using NFA (Nondeterministic Finite Automaton). NFA is an object that changes a state in accordance with an accepted input. Specifically, the occurrence counting unit 112 uses two kinds of NFA called NFAf and FFAb. About NFA, see G. Navarro and M. Raffinot, Flexible Pattern Matching in String, Cambridge Univ. Press, 2002, for example.

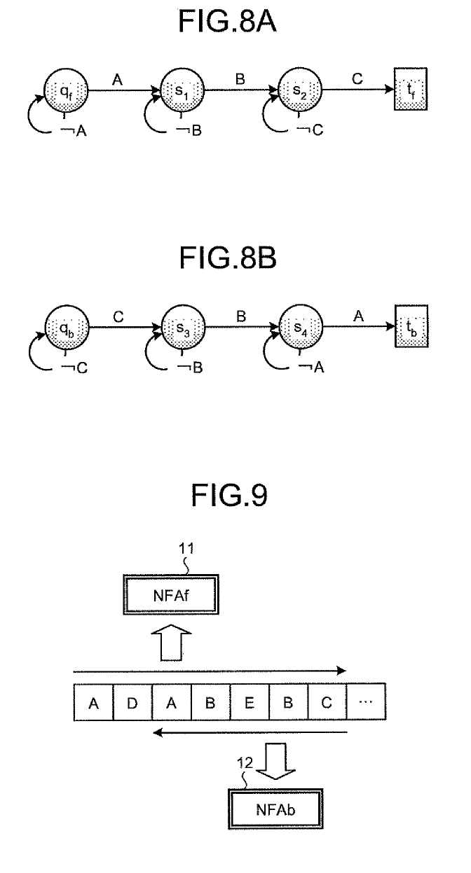

FIG. 8A is a diagram illustrating an example of NFAf. NFAf is NFA for detecting a candidate pattern in normal order. For example, if the candidate pattern is “A*B*C”, an initial state is changed to a first state when a trace record whose type of record is “A” is input. Subsequently, the first state is changed to a second state when a trace record whose type of record is “B” is input. Then, the second state is changed to a state indicating detection of the candidate pattern when a trace record whose type of record is “C” is input.

FIG. 8B is a diagram illustrating an example of NFAb. NFAb is NFA for detecting a candidate pattern in reverse order. For example, if the candidate pattern is “A*B*C”, an initial state is changed to a first state when a trace record whose type of record is “C” is input. Subsequently, the first state is changed to a second state when a trace record whose type of record is “B” is input. Then, the second state is changed to a state indicating detection of the candidate pattern when a trace record whose type of record is “A” is input.

FIG. 9 is a diagram illustrating a detection example of a candidate pattern using NFA. As illustrated in FIG. 9, the occurrence counting unit 112 first detects a candidate pattern in normal order by using NFAf 11. If the candidate pattern is “A*B*C”, the occurrence counting unit 112 detects the candidate pattern in a part of “A” “D” “A” “B” “E” “B” “C” as in FIG. 9 and definitely determines the end of the detected part as the end of the part matched with the candidate pattern.

Next, the occurrence counting unit 112 detects the candidate pattern in reverse order by using NFAb 12 by using the determined end as a base point. The occurrence counting unit 112 detects the candidate pattern in a part of “A” “B” “E” “B” “C” as in FIG. 9 and definitely determines the head of the detected part as the head of the part matched with the candidate pattern. In this manner, by combining two types of normal-order and reverse-order NFA, it is possible to count the number of occurrences of the candidate pattern while separating the list so that the occurrence length is minimum.

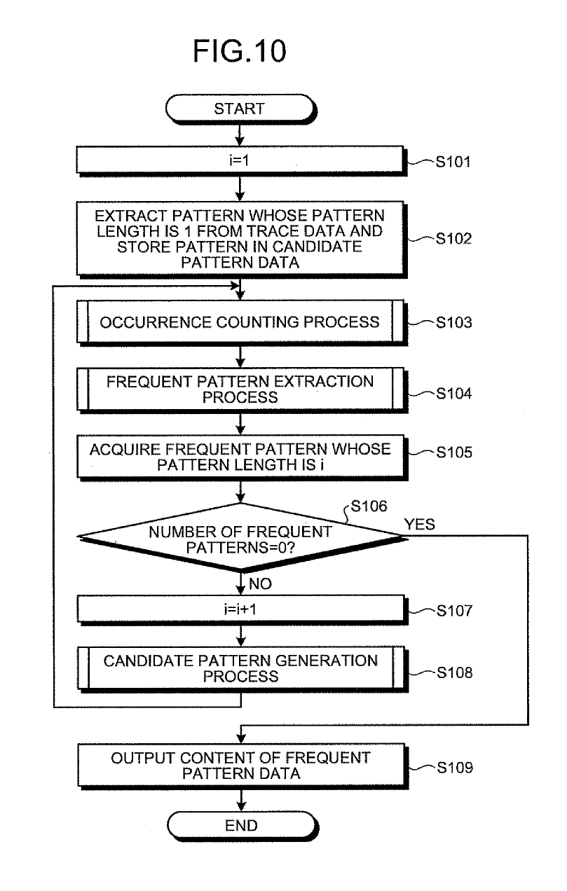

Next, the processing procedure of the performance bottleneck analysis apparatus 100 illustrated in FIG. 4 will be explained. FIG. 10 is a flowchart of the processing procedure of the performance bottleneck analysis apparatus 100. As illustrated in FIG. 10, the control unit 110 first initializes a variable i indicating a pattern length to one (Step S101). Then, the candidate pattern generating unit 111 stores a candidate pattern whose pattern length is one in the candidate pattern data 122 (Step S102). It is obvious that the candidate pattern whose pattern length is one is a pattern including all items.

Next, the occurrence counting unit 112 executes an occurrence counting process described below to count the number of occurrences of the candidate pattern whose pattern length is i and set the count value in the candidate pattern data 122 (Step S103).

Next, the frequent pattern extracting unit 113 executes a frequent pattern extraction process described below to extract a frequent pattern whose pattern length is i and stores the frequent pattern in the frequent pattern data 123 (Step S104). In this case, the control unit 110 acquires the number of frequent patterns whose pattern length is i (Step S105). If the number of frequent patterns is not zero (Step S106: NO), the control unit 110 increments the value of the variable i by one (Step S107).

Next, the candidate pattern generating unit 111 executes a candidate pattern generation process described below to generate a candidate pattern whose pattern length is i based on a frequent pattern whose pattern length is i−1 (Step S108). After that, the process is resumed from Step S103. The occurrence counting unit 112 executes the occurrence counting process to count the number of occurrences of the candidate pattern whose pattern length is i (Step S103) and execute the next process similarly to the above.

If the number of frequent patterns, whose pattern length is i, acquired in Step S105 is zero (Step S106: YES), the control unit 110 causes the analysis result outputting unit 114 to output the content of the frequent pattern data 123 as an analysis result (Step S109). After that, the control unit 110 terminates the process.

For the convenience of explanation of a common flow, the explanation is given below in order of the candidate pattern generation process (Step S108), the occurrence counting process (Step S103), and the frequent pattern extraction process (Step S104).

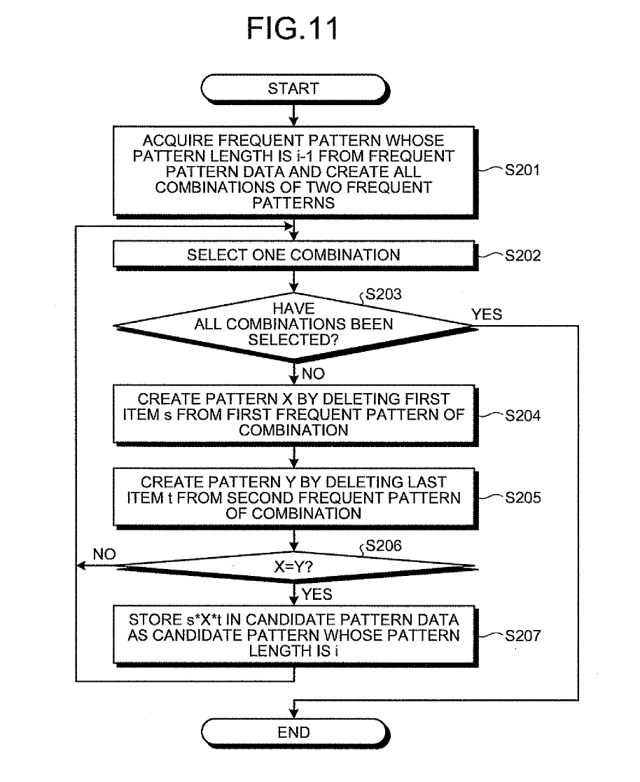

FIG. 11 is a flowchart of the processing procedure of the candidate pattern generation process. For example, when a pattern “A*B*C*D” appears frequently, a pattern “A*B*C” excepting the last item and a pattern “B*C*D” excepting the first item also appear frequently. Using this logic, the candidate pattern generating unit 111 suppresses the increase of the number of candidate patterns accompanying the increase of pattern length. Thus, a frequent pattern can be efficiently extracted.

Specifically, the candidate pattern generating unit 111 first acquires a frequent pattern whose pattern length is i−1 from the frequent pattern data 123 and creates all combinations of two frequent patterns (Step S201).

Then, the candidate pattern generating unit 111 selects one of the combinations which have not been selected (Step S202). When there is a combination to be selected (Step S203: NO), the candidate pattern generating unit 111 creates a pattern X by deleting a first item s from the first frequent pattern of the combination (Step S204). Furthermore, the candidate pattern generating unit 111 creates a pattern Y by deleting a last item t from the second frequent pattern of the combination (Step S205).

If the pattern X is the same as the pattern Y (Step S206: YES), a pattern s*X*t that is obtained by adding the item s to the front of the pattern X and the item t to the rear of the pattern X may appear frequently. Therefore, the candidate pattern generating unit 111 registers the pattern s*X*t in the candidate pattern data 122 as a candidate pattern whose pattern length is i (Step S207). After that, the candidate pattern generating unit 111 returns to Step S202 and selects another one of the combinations not yet selected.

On the other hand, if the pattern X is not the same as the pattern Y (Step S206: NO), there is no possibility that the pattern s*X*t that is obtained by adding the item s to the front of the pattern X and the item t to the rear of the pattern X appear frequently. Therefore, the candidate pattern generating unit 111 does not register the pattern s*X*t in the candidate pattern data 122 as a candidate pattern whose pattern length is i. After that, the candidate pattern generating unit 111 returns to Step S202 and selects another one of the combinations not yet selected.

Then, when all the combinations are acquired in Step S202 (Step S203: YES), the candidate pattern generating unit 111 terminates the process.

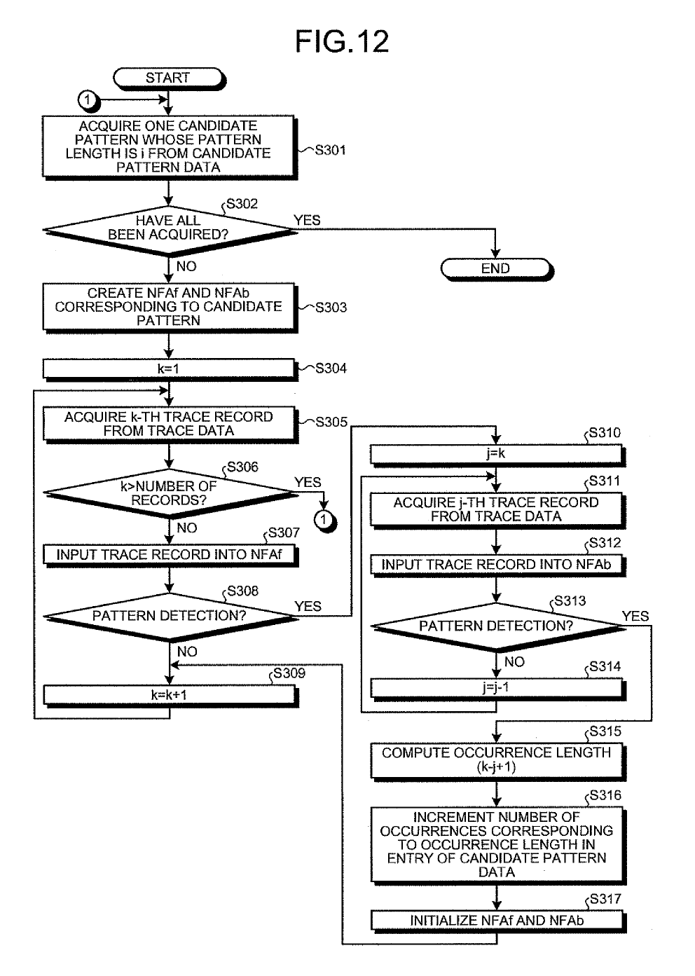

FIG. 12 is a flowchart of the processing procedure of the occurrence counting process. As illustrated in FIG. 12, the occurrence counting unit 112 first acquires one candidate pattern which has not been acquired and whose pattern length is i from the candidate pattern data 122 (Step S301). When a candidate pattern which has not been acquired can be acquired (Step S302: NO), the occurrence counting unit 112 creates NFAf and NFAb corresponding to the acquired candidate pattern (Step S303).

Then, the occurrence counting unit 112 initializes a variable k indicating the position of trace record to one (Step S304) and acquires a k-th trace record from the trace data 121 (Step S305). When k is larger than the number of records of the trace data 121 and a trace record cannot be acquired (Step S306: YES), the occurrence counting unit 112 returns to Step S301 and acquires another candidate pattern which has not been acquired and whose pattern length is i from the candidate pattern data 122.

On the other hand, when a trace record can be acquired

(Step S306: NO), the occurrence counting unit 112 inputs the acquired trace record into NFAf (Step S307). Then, if the state of NFAf is not changed to a state indicating the detection of the candidate pattern (Step S308: NO), the occurrence counting unit 112 increments the value of the variable k by one (Step S309) and resumes the process from Step S305.

When the state of NFAf is changed to the state indicating the detection of the candidate pattern (Step S308: YES), the occurrence counting unit 112 sets the value of the current variable k to the value of a variable j (Step S310) and acquires a j-th trace record from the trace data 121 (Step S311). The occurrence counting unit 112 then inputs the acquired trace record into NFAb (Step S312). If the state of NFAb is not changed to a state indicating the detection of the candidate pattern (Step S313: NO), the occurrence counting unit 112 decrements the value of the variable j by one (Step S314) and resumes the process from Step S311.

When the state of NFAb is changed to the state indicating the detection of the candidate pattern (Step S313: YES), the occurrence counting unit 112 calculates k-j+1 to compute an occurrence length (Step S315). The occurrence counting unit 112 then increments by one the number of occurrences, corresponding to the occurrence length, of an entry identical with the candidate pattern which is acquired from the candidate pattern data 122 in Step S301 and whose pattern length is i (Step S316). Then, the occurrence counting unit 112 initializes NFAf and NFAb (Step S317) and then executes the process from Step S309.

When all candidate patterns are acquired in Step S301 (Step S302: YES), the occurrence counting unit 112 terminates the process.

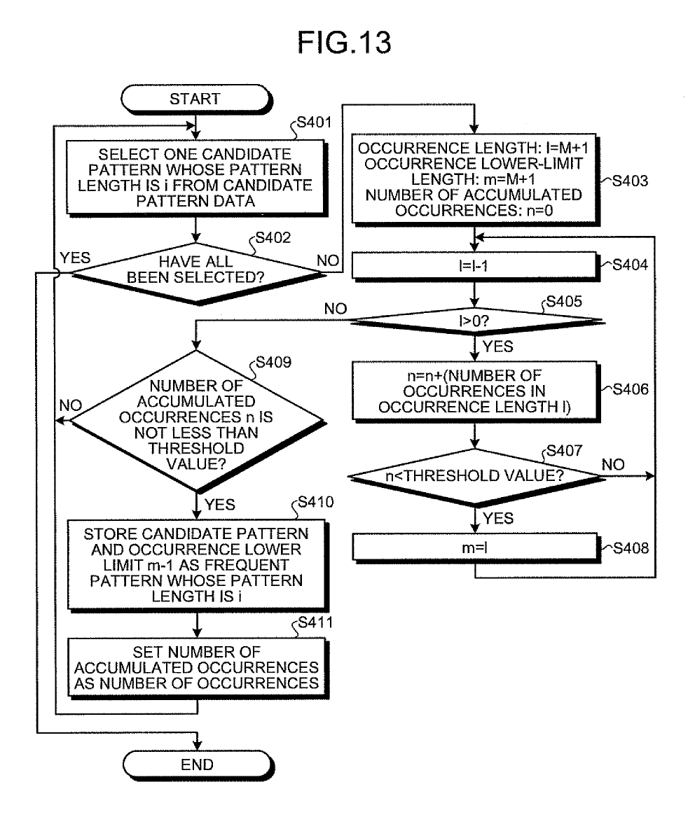

FIG. 13 is a flowchart of the processing procedure of the frequent pattern extraction process. As illustrated in FIG. 13, the frequent pattern extracting unit 113 first acquires one candidate pattern which has not been acquired and whose pattern length is i from the candidate pattern data 122 (Step S401). When a candidate pattern which has not been acquired can be acquired (Step S402: NO), the frequent pattern extracting unit 113 searches a lower limit of an occurrence length in accordance with the following procedure. The lower limit is used for determining whether a candidate pattern is a frequent pattern.

First, the frequent pattern extracting unit 113 initializes a counter 1 indicating the occurrence length and a counter m indicating the occurrence lower limit to M+1 and initializes a counter n indicating the number of accumulated occurrences to zero(Step S403). Here, M is the maximum value of the occurrence length of the candidate pattern. In the candidate pattern data (FIG. 5), M is an index storing a non-zero value that is located at the rightmost position in a “number of occurrences” field. Next, the frequent pattern extracting unit 113 decrements the counter l by one (Step S404). If l is larger than zero (Step S405: YES), the frequent pattern extracting unit 113 adds the number of occurrences of the candidate pattern whose occurrence length is l to the number of accumulated occurrences n (Step S406). Furthermore, when the number of accumulated occurrences n is smaller than a threshold value that is used for the determination of frequent pattern (Step S407: YES), the frequent pattern extracting unit 113 assigns l to the occurrence lower limit m (Step S408) and resumes the process from Step S404. On the other hand, if the occurrence length l is not larger than zero (Step S405: NO), the frequent pattern extracting unit 113 jumps to Step S409.

Then, when the number of accumulated occurrences n is not less than the threshold value that is used for the determination of frequent pattern (Step S409: YES), the frequent pattern extracting unit 113 causes the frequent pattern data 123 to store the acquired candidate pattern and the occurrence lower-limit length m−1 as a frequent pattern whose pattern length is i (Step S410). Then, the frequent pattern extracting unit 113 sets the counted number of occurrences as the number of occurrences of the entry (Step S411) and resumes the process from Step S401.

On the other hand, if the counted number of accumulated occurrences n is smaller than the threshold value that is used for the determination of frequent pattern (Step S409: NO), the frequent pattern extracting unit 113 does not register the candidate pattern as a frequent pattern and resumes the process from Step S401.

When all candidate patterns are acquired in Step S401 (Step S402: YES), the frequent pattern extracting unit 113 terminates the process.

It should be noted that the configuration of the performance bottleneck analysis apparatus 100 according to the present embodiment illustrated in FIG. 4 can be changed without departing from the scope of the invention. For example, the invention can provide a function of the control unit 110 of the performance bottleneck analysis apparatus 100 as software and make a computer execute the function. Such a configuration can realize the same function as that of the performance bottleneck analysis apparatus 100. Hereinafter, an explanation is given on an example of a computer that executes a performance bottleneck analysis program 1071 including the function of the control unit 110 as software.

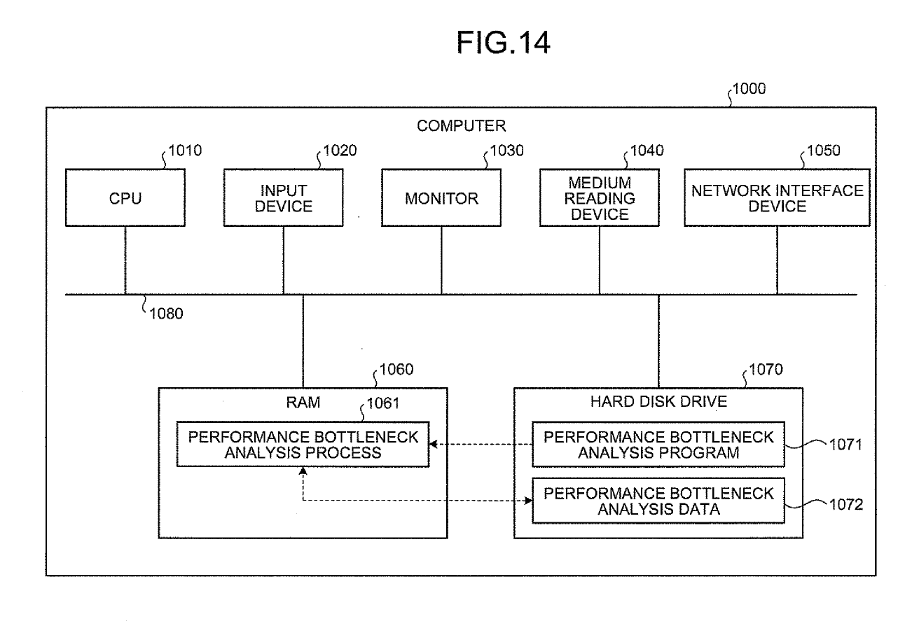

FIG. 14 is a functional block diagram of a computer 1000 that executes the performance bottleneck analysis program 1071. The computer 1000 includes a CPU 1010, an input device 1020, a monitor 1030, a medium reading device 1040, a network interface device 1050, a Random Access Memory (RAM) 1060, and a hard disk drive 1070, which are connected through a bus 1080. The CPU 1010 executes various types of arithmetic processing. The input device 1020 accepts data input from a user. The monitor 1030 displays various types of information. The medium reading device 1040 reads a program or the like from a recording medium. The network interface device 1050 sends and receives data between the computer and other computers via network. The RAM 1060 temporarily stores various types of information.

The hard disk drive 1070 stores the performance bottleneck analysis program 1071 having the same function as that of the control unit 110 illustrated in FIG. 4 and performance bottleneck analysis data 1072 corresponding to various types of data stored in the storage unit 120 illustrated in FIG. 4. The performance bottleneck analysis data 1072 can be appropriately distributed to be stored in other computers that are connected via network.

When the CPU 1010 reads the performance bottleneck analysis program 1071 from the hard disk drive 1070 and loads the program on the RAM 1060, the performance bottleneck analysis program 1071 functions as a performance bottleneck analysis process 1061. The performance bottleneck analysis process 1061 appropriately loads information read from the performance bottleneck analysis data 1072 on an area on the RAM 1060 assigned to the process and executes various types of data processing based on the loaded data.

The performance bottleneck analysis program 1071 is not necessarily stored in the hard disk drive 1070. Such a program can be stored in a storage medium such as CD-ROM. In this case, the computer 1000 can read and execute the program. Moreover, such a program can be stored in other computers or servers that are connected to the computer 1000 via a public line, Internet, Local Area Network (LAN), Wide Area Network (WAN), or the like. In this case, the computer 1000 can read the program from the other computers and execute the program.

Moreover, an embodiment obtained by applying components, expressions, or an arbitrary combination of the components of the present invention to a method, an apparatus, a system, a computer program, a recording medium, a data structure, or the like is also valid as an aspect of the present invention.

As described above, according to an embodiment, because a part executed frequently in a program is extracted based on an occurrence pattern of a trace record output according to a function or a macro which can be embedded at an arbitrary point in the program, the part of the program of which the number of runs is large can be extracted irrespective of the granularity of functions constituting the program.

According to an embodiment, because a frequently-executed part is extracted by counting only the number of occurrences of a part for which the occurrence pattern of the trace record is long, a part of a program of which the number of runs is large and the runtime is long can be extracted irrespective of the granularity of functions constituting the program.

According to an embodiment, because the number of occurrences of the occurrence pattern is counted while the list is separated so that the occurrence pattern of the trace record is shortest, the number of occurrences can be counted in a single uniform way.

According to an embodiment, because the candidate of another frequent pattern can be generated by combining frequent patterns, the candidate of frequent pattern can be narrowed down and a processing time can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer readable storage medium containing instructions for outputting information related to a bottleneck point in a program based on trace records that are output when a predetermined point of the program is executed, the instructions, when executed by a computer, causing the computer to perform:
generating candidate patterns of the trace records in an array in which the trace records are stored in an output order;
counting the number of occurrences of parts matched with each generated candidate pattern in the array;
extracting, when the number of occurrences of the generated candidate pattern is not less than a predetermined occurrence threshold, the candidate pattern as a frequent pattern to obtain an extraction result based on the counted number of occurrences; and
outputting the extraction result as an analysis result.

2. The computer readable storage medium according to claim 1, wherein the candidate pattern is extracted as the frequent pattern based on a condition that a length of the part matched therewith is not less than a certain value, when an added-up number of the numbers counted in the counting is not less than a predetermined value.

3. The computer readable storage medium according to claim 1, wherein the number of occurrences is counted so that a length of the part matched with the candidate pattern is shortest.

4. The computer readable storage medium according to claim 3, wherein the number of occurrences is counted so that the parts matched with the candidate pattern do not overlap with each other.

5. The computer readable storage medium according to claim 1, wherein the candidate pattern is generated by combining the frequent patterns.

6. An apparatus for outputting information related to a bottleneck point in a program based on trace records that are output when a predetermined point of the program is executed, the apparatus comprising:
a candidate pattern generating unit that generates candidate patterns of the trace records in an array in which the trace records are stored in an output order;
an occurrence counting unit that counts the number of occurrences of parts matched with each candidate pattern generated by the candidate pattern generating unit in the array;
a frequent pattern extracting unit that extracts, when the number of occurrences of the candidate pattern generated by the candidate pattern generating unit is not less than a predetermined occurrence threshold, the candidate pattern as a frequent pattern to obtain an extraction result based on the number of occurrences counted by the occurrence counting unit; and
an analysis result outputting unit that outputs the extraction result of the frequent pattern extracting unit as an analysis result.

7. The apparatus according to claim 6, wherein
the frequent pattern extracting unit extracts the candidate pattern as the frequent pattern based on a condition that a length of the part matched therewith is not less than a certain value, when an added-up number of the numbers counted in the counting is not less than a predetermined value.

8. The apparatus according to claim 6, wherein
the occurrence counting unit counts the number of occurrences so that a length of the part matched with the candidate pattern is shortest.

9. The apparatus according to claim 8, wherein
the occurrence counting unit counts the number of occurrences so that the parts matched with the candidate pattern do not overlap with each other.

10. The apparatus according to claim 6, wherein
the candidate pattern generating unit generates the candidate pattern by combining the frequent patterns extracted by the frequent pattern extracting unit.

11. A method for outputting information related to a bottleneck point in a program based on trace records that are output when a predetermined point of the program is executed, the method comprising:
generating candidate patterns of the trace records in an array in which the trace records are stored in an output order;
counting the number of occurrences of parts matched with each generated candidate pattern in the array;
extracting, when the number of occurrences of the generated candidate pattern is not less than a predetermined occurrence threshold, the candidate pattern as a frequent pattern to obtain an extraction result based on the counted number of occurrences; and
outputting the extraction result as an analysis result.

12. The method according to claim 11, wherein the candidate pattern is extracted as the frequent pattern based on a condition that a length of the part matched therewith is not less than a certain value, when an added-up number of the numbers counted in the counting is not less than a predetermined value.

13. The method according to claim 11, wherein the number of occurrences is counted so that a length of the part matched with the candidate pattern is shortest.

14. The method according to claim 13, wherein the number of occurrences is counted so that the parts matched with the candidate pattern do not overlap with each other.

15. The method according to claim 11, wherein the candidate pattern is generated by combining the frequent patterns.
